(19) United States
(12) Patent Application Publication
(10) Pub. No.: US 2016/0328282 A1
(43) Pub. Date: Nov. 10, 2016

(54) PREDICTIVE DEVICE FAILURE ANALYSIS

(71) Applicants: Monica Rogati, Sunnyvale, CA (US); Walter Gong, Redwood City, CA (US); Dileep Goyal, Fremont, CA (US); Hari N. Chakravarthula, San Jose, CA (US); Adrienne Huesca, San Francisco, CA (US)

(72) Inventors: Monica Rogati, Sunnyvale, CA (US); Walter Gong, Redwood City, CA (US); Dileep Goyal, Fremont, CA (US); Hari N. Chakravarthula, San Jose, CA (US); Adrienne Huesca, San Francisco, CA (US)

(73) Assignee: AliphCom, San Francisco, CA (US)

(21) Appl. No.: 14/705,917

(22) Filed: May 6, 2015

(51) Int. Cl. G06F 11/07

(52) U.S. Cl. CPC G06F 11/0772; G06F 11/0709; G06F 11/076; G06F 11/079

(57) ABSTRACT

An electronic device may include hardware and software configured to detect device failures in the electronic device and log a device error code for detected device failures. Device error codes may be electronically communicated over a communications link to a system external to the electronic device. A client device (e.g., a smartphone, tablet, pad, or PC) may be linked with the electronic device and may be configured to receive the communicated device error codes. The client device may be operative to communicate the received device error codes to another system (e.g., a backend system). The electronic device may link with the backend system and communicate the device error codes to the backend system. Networked computing resources in communication with the backend system may analyze the received error codes to determine whether or not to communicate a device replacement notice. A customer profile may be used as part of the analysis.

### FIELD

Embodiments of the present application relate generally to hardware, software, firmware, application programming interfaces (API's), wired and wireless communications, RF systems, wireless devices, wireless media devices, wearable devices, biometric devices, and consumer electronic (CE) devices.

### BACKGROUND

As electronic devices continue to evolve and continue to be adopted by more users for a variety of purposes, many of those devices are configured for data communications using one or more communications mediums, such as wired and/or wireless communication, for example. However, electronic devices may fail due to a variety of failure modes, such as one or more of a hardware failure, a software failure, or a mechanical failure, for example. In some instances, failure of an electronic device may result in a customer (e.g., a user of the electronic device) calling customer service for assistance in remedying the failure.

A call to customer service may be costly to a manufacturer of the electronic device because each customer service call may be charged at a by-the-minute or some other rate (e.g., $0.50/minute or more). Call length (e.g., a call lasting ten minutes or more) and the number of calls made to customer service may affect an overall profit and loss (P&L) for a product. If a manufacture has a large number of electronic devices deployed to customers and a large enough percentage of those customers are likely to call customer service to resolve problems that may arise with their electronic devices, then the manufacturer may be exposed to a potential loss of profits and/or reduced profit margins that may arise from expenses due to customer service calls, in addition to other costs (e.g., replacement costs, shipping costs, logistics costs).

Accordingly, there is a need for systems, apparatus and methods that proactively analyze device failure and offer customers a remedy for failed devices that effectively eliminates or reduces the need for customers to call customer service.

### BRIEF DESCRIPTION OF THE DRAWINGS

Various embodiments or examples (“examples”) are disclosed in the following detailed description and the accompanying drawings:

FIG. 1 depicts one example of a block diagram of a device configured to log and transmit data representing device error codes to an external device;

FIG. 2 depicts one example of a flow diagram to log and transmit device error codes on an electronic device;

FIG. 3 depicts one example of a flow diagram to receive data representing device error codes and to determine whether or not to replace a device;

FIG. 4 depicts examples of devices communicating logged errors to external devices;

FIG. 5 depicts one example of a backend system;

FIG. 6 depicts a diagram of device error codes and a table of data that may be used as part of a device replacement determination; and

FIG. 7 depicts one example of a computer system.

Although the above-described drawings depict various examples of the invention, the invention is not limited by the depicted examples. It is to be understood that, in the drawings, like reference numerals designate like structural elements. Also, it is understood that the drawings are not necessarily to scale.

### DETAILED DESCRIPTION

Various embodiments or examples may be implemented in numerous ways, including but not limited to implementation as a device, a wireless device, a system, a process, a method, an apparatus, a user interface, or a series of executable program instructions included on a non-transitory computer readable medium. Such as a non-transitory computer readable medium or a computer network where the program instructions are sent over optical, electronic, or wireless communication links and stored or otherwise fixed in a non-transitory computer readable medium. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

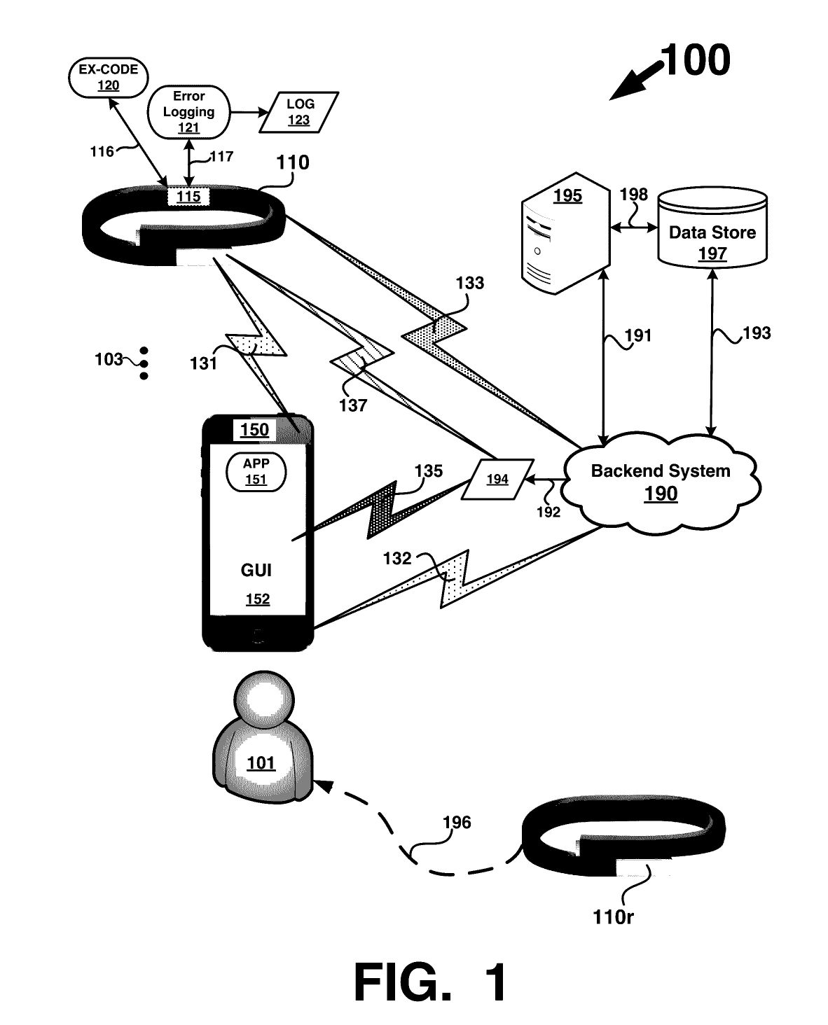

FIG. 1 depicts one example of a block diagram 100 of a device configured to log and transmit data representing device error codes to an external device. A device 110 (e.g., a wearable device) may include a system 115 that includes hardware (e.g., a processor, an ASIC, etc.), circuitry (e.g., a radio frequency (RF) system, discrete components), sensors (e.g., motion sensors, biometric sensors, etc.), a power supply (e.g. a re-chargeable battery, voltage regulators, etc.), memory (e.g., volatile and/or non-volatile), and other structure, such as wires and PC board traces, for example. Memory may include machine executable code 120 (e.g., an operating system—OS, algorithms for processing sensor data, etc.) accessed 116 by system 115 and configured to execute on a processor or the like in system 115.

Failures in hardware and/or software components of system 115 in device 110 may be monitored by an error logging algorithm 121 that may receive 117 signals and/or data from system 115. For example, a software failure may manifest as a hardware failure or malfunction in one or more hardware components or systems in 115. Error logging algorithm 121 may monitor signals and/or data received 117 from system and process those signals and/or data to determine if the signals and/or data are indicative of a failure (e.g., an actual failure or a potential failure) of hardware and/or a software component(s) of system 115, and generate a device error code specific to the failure.

Error logging algorithm 121 may log data representing each device error code in an error log 123 (e.g., a data store, a file, a memory). Error logging algorithm 121 may operate in conjunction with error detecting hardware in system 115 (e.g., built-in-self-test or other circuitry/hardware for self-test of device 110). For example, during boot-up of a processor of system 115, a boot-up error may be communicated 117 to error logging algorithm 121 and may result in generation of a device error code for a boot-up error/failure being stored in log 121 or communicated (131, 133) to an external device.

Device error codes stored in error log 123 may be communicated 131 (e.g., using a wired and/or wireless communications link) to an external device or system, such as computing device 150 (e.g., a smartphone, tablet, pad or laptop computer). Computing device 150 may include an application APP 151 or other form of machine executable code that receives the data representing the device error codes stored in error log 123 and communicates 132 the data representing the device error codes to an external system, such as a backend system 190, for example. In other examples, device 110 may communicate 133 the data representing the device error codes to the backend system 190 (e.g., bypass computing device 150). Portal computing devices, such as WiFi routers or cellular communications networks may serve as communications links between one or more of the devices and/or systems depicted in FIG. 1.

In some examples, device error codes may be accumulated in log 123 and then communicated (e.g., transmitted via links 131 or 133) to an external device or system. Communication of the accumulated device error codes may occur at a time (e.g., at 4:00 am), after a number of device error codes have been accumulated (e.g., two or more device error codes), or upon establishing a communications link with an external device or system (e.g., 150 and/or 190). In other examples, device error codes may be communicated as they are determined by error logging algorithm 121. For example, the above described boot-up error may be received 117 and then communicated (131, 133) in real-time or near real-time by error logging algorithm 121. Device error codes that are communicated as they occur (e.g., in real-time or near real-time) may still be logged in log 123.

Backend system 190 may include or be in communication with (191, 193) one or more resources, such as a computing device 195 (e.g., a server) and a data store 197 (e.g., network attached storage (NAS), hard drive (HD), solid state drive (SSD), RAID, Cloud storage, a data base, etc.). Computing device 195 and data store 197 may be in communication 198 with each other. Backend system 190 may process the data representing the device error codes and may determine, based on data extracted from the data representing the device error codes and/or data accessed from data store 197, whether or not to generate 192 a device replacement notice 194. The device replacement notice 194 may be an electronic message (e.g., an email, text message, SMS, Tweet, instant message, voice mail, phone call, video, or the like). In other examples, the device replacement notice 194 may be a letter, postcard or other non-electric form of communications. Device replacement notice 194 may be configured to inform a customer 101 (e.g., a user of device 110) of an offer to replace the customer's 101 current device 110 with a replacement device. Device replacement notice 194 may be communicated 132 to computing device 150 and/or communicated 137 to device 110. Device replacement notice 194 may be configured for presentation on a display 152 of computing device 150, for example. Device replacement notice 194 may be communicated to a customer service data store (not shown) and the data representing the device replacement notice may be accessed from the customer service data store and may be used to initiate contact with the customer 101 regarding matters concerning a replacement device 110r that may be used to replace the device 110. The customer service data store may be accessed to determine whether or not the customer 101 has taken steps to procure 196 the replacement device 110r (e.g., shipping instructions, e-commerce delivery instructions, retailer pick-up instructions), provide customer 101 with instructions on how to procure the replacement device 110r, provide customer 101 with instructions on how to return the device 110 (e.g., for failure analysis), generate a follow-up communication with the customer (e.g., an electronic message) concerning device 110 and/or replacement device 110r, for example.

Backend system 190 may receive (131, 133) and process device error codes from more than one device 110 as denoted by 103 and the types of devices and any associated computing devices (e.g., 150) need not be the same. Data representing device error codes from multiple devices that is received by backend system 150 may be processed in real-time or near real-time to determine if one or more of the multiple devices will have device replacement notices 194 generated based on an indication of device failure. A determination as to whether or not to generate the device replacement notice 194 for one or more of the devices may be based in part or in whole on historical data accessed from data store 197 and/or real-time data accessed from the multiple devices. As one example, if 255 of the devices 110 are communicating (131, 133) data representing device error codes to backend system 150 and 15 of the 255 devices are reporting device error code ERR 27; Temp Sensor Failure“, backend system 150 may access (e.g., from data store 197) historical failure data obtained from past processing of devices that are the same or similar to devices 110 and determine if ERR 27 warranted replacement of those devices, and if replacement was warranted, then generate device replacement notices 194 for the 15 devices. More to this example, if 35 of the 255 devices are reporting device error code ERR 15; Bioimpedance Sensor Intermittent Data”, and there is no historical failure data from past processing of devices that are the same or similar to devices 110, backend system 150 may access (e.g., from data store 197) other failure data that may be used to determine whether ERR 15 warrants replacement of those devices. Further to this example, the other failure data accessed may include data representing failures that may always warrant replacement of a device, such as an indicated failure of a sensor (e.g., a bioimpedance sensor). Accordingly, in an absence of historical failure data, backend system 150 may generate device replacement notices 194 for the 35 devices indicating the bioimpedance sensor failure (e.g., ERR 15). Device error codes may include more, less or different information than described in the above examples for ERR 27 and ERR 15.

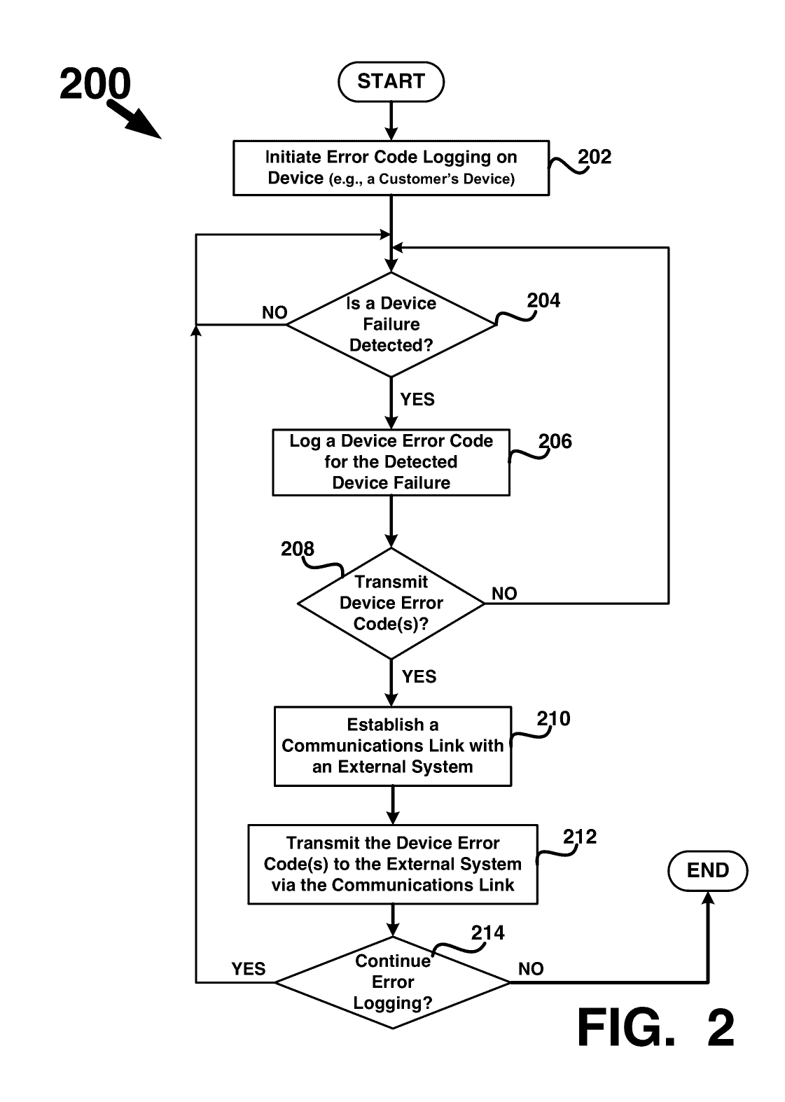

Referring now to FIG. 2 that depicts one example of a flow diagram 200 to log and transmit device error codes on a device (e.g., an electronic device of a customer). At a stage 202 error code logging on a device may be initiated. For example, an error logging algorithm (e.g., 121 of FIG. 1) may be executed on a processing unit (e.g., CPU, controller, ASIC, FPGA, μP, or μC) of a device (e.g., device 110) to initiate the error logging. The error logging algorithm may be embodied in a non-transitory computer readable medium that includes program instructions configured to execute on the processing unit. A data store electronically accessible by the processing unit, such as non-volatile memory in the device, may include the error logging algorithm. In some examples, the error logging algorithm may be included in firmware for the device. In some examples, the error logging algorithm may be included in a data store internal to the processing unit (e.g., embedded memory).

The device may include but is not limited to a wireless device, a wearable device, a wrist-wearable device, a data capable strap band, a biometric device, a health monitoring/tracking device, a fitness monitoring/tracking device, a speaker box, a wireless speaker box, a portable device, a wired device, a headset, a wireless headset, a headphone, a wireless headphone, an earpiece, a wireless earpiece, a media device, a wireless media device, eyeglasses, a display device, a wearable display, a tablet, a pad, a laptop, a PC, a computer, a server, a media server, a data storage device, a HVAC device, an appliance, just to name a few, for example. In some examples, the device may be configured for wireless communication (e.g., Bluetooth (BT), BT Low Energy (BTLE), WiFi, WiMAX, WiFi Direct, near field communication (NFC), HackRF, AdHoc WiFi, Software defined Radio (SDR), short range RF communication, one or more varieties of IEEE 802.x, or other wireless protocols). In other examples, the device may be configured for wired communication (e.g., LAN, Ethernet, USB, Lightning, Thunderbolt, FireWire (IEEE-1394), RS-232 or other wired protocols). In another example, the device may be configured for wireless and wired communications.

At a stage 204 a determination may be made as to whether or not a device failure has been detected. A device failure may include but is not limited to a hardware failure (e.g., circuitry, an electronic failure, a biometric sensor failure, a bioimpedance sensor failure, a motion sensor failure, a power system failure, an electrical failure, an electrical continuity failure, etc.), a software failure, a mechanical and/or structural failure that may be detected by circuitry and/or systems of the device, just to name a few, for example. In some examples, a software failure may be detected indirectly as a hardware failure that may arise due to a software failure. If a NO branch is taken from the stage 204, then flow 200 may transition to another stage, such as back to the stage 204, for example. If a YES branch is taken from the stage 204, then flow 200 may transition to a stage 206, for example.

At the stage 206, data representing a device error code for the detected device failure may be logged. Logging of the data representing device error code may include but is not limited to storing or saving detected device error codes in a data store, in a register, in a data base, in non-volatile memory, or in some other form of memory. In some example, logging of data representing device error code or codes may include transmitting the device error code(s) to an external system (e.g., 150 and/or 190 via a wired and/or wireless communications link), for example. The error logging algorithm described above in reference to the stage 202 may include data and/or have access to data, such as a look-up table, hash table, or some other form of data structure that may include data representing one or more device error codes, where data representing each device error code may be associated with one or more device failures. Data representing a device error code need not specifically identify the exact cause and/or component that gave rise to the device error code. For example, if the data representing the device error code is indicative of a power system failure, then that failure may be due to a defective power source (e.g., a battery), may be due to a defective voltage regulator or both.

Data representing device error codes may include formatted data and may further include other data, such as a time stamp and/or a date stamp for when the device failure that prompted the device error code occurred. Actual format and data included in a device error code may be application specific and is not limited to examples described herein. An application or other forms of machine executable instructions may be used to format data for the device error codes. For example, an application executing on a processor of a device that generates the device error codes may format data representing the device error codes into a format configured to be received and/or processed by an external system, process or device. In other examples, a device error code may be formatted by an external device or system and may be received by the external device or system as data representing un-formatted device error code(s). For example, computing device 150 and/or backend system 190 may receive (131, 133) data representing un-formatted device error code(s) from device 110 and may generate data representing formatted device error code(s) from the un-formatted device error code(s). Further to the example, application 151 (e.g., as downloaded from an APP stored) on computing device 150 may access the data representing un-formatted device error code(s) and generate data representing formatted device error code(s).

Example formats for data representing device errors code for a detected device failure for a particular device may include but are not limited to: “ERR 5; Clock/Oscillator Failure; 07/21/2014; 11:54:05; PM; PST”; “ERR 7; BT Radio TX Failure; 07/23/2014; 12:37:47; AM; EST”, ERR 9; BI Sensor Failure; 12/24/2014; 01:29:17; AM; MST″. Here the first device error code is device error code 5 for clock or oscillator failure that occurred on Jul. 21, 2014 at eleven-fifty-four PM and five seconds, Pacific Standard Time; whereas, the second device error code is device error code 7 for a Bluetooth Radio Transmit failure that occurred on Jul. 23, 2014 at twelve-thirty-seven AM and forty-seven seconds, eastern standard time, and the third device error code 9 is for a bioimpedance sensor failure on Dec. 24, 2014 at one-twenty-nine AM and seventeen seconds, mountain standard time. Other types of hard and/or soft hardware failures such as motion sensor failures (e.g., gyroscope, accelerometer), optical sensor failures (e.g., an opto-electronic device), a display failure (e.g., LCD, LED, OLED, etc.), temperature sensor failures, power system failures (e.g., a lithium-ion battery), input/output device failure (e.g., a USB port), continuity failure (e.g., a wire or a PC board trace), and the like may be assigned appropriate device error codes. Time and/or date stamps, if included in a device error code, may include more or less time granularity, such as time of occurrence down to millisecond, microseconds, etc., for example. If device error codes include ASCII characters, then the format for the device error code may include one or more characters that may be used as field or data separators, such as the semi-colon “;” character, for example. In some examples, device error codes may include Hex-code, binary code or other coding formats. Data representing one or more device error codes may be formatted into one or more data packets that may include one or more fields such as a header, a data payload, an error correction/detection field, just to name a few, for example. Device error codes may include information specific to the device, such as serial number, model number, lot number, manufacturing date, firmware version, warranty information, operating system version, device customization data (e.g., bespoke customizations tailored for a specific customer 101), place/location of manufacturing, software and/or hardware version numbers, etc., just to name a few. The number of device error codes that may be detected may not include all possible failure modes or mechanisms for a given device. A finite number of device error codes may be implemented to detect failures including but not limited to those that are detectable using the hardware and/or software resources of the device (e.g., device 110), specific failures of interest to the manufacture of the device, failures that historically are desirable to detect, failures that are deemed by the manufacture to have a higher importance (e.g., a sensor failure), just to name a few. In some examples, device error codes may be updated, corrected, revised, added to, amended, deleted, combined with other device error code(s), or replaced using an update process, such as a software, firmware, OS update, or BIOS update. An application (e.g., APP 151 on device 150) or other form of machine executable code may include revisions to device error codes (e.g., from an update of the application) and may transmit the revised device error codes to the device (e.g., device 110) using one or more communications links (e.g., 131). An external system (e.g., backend system 150) may be configured to establish a communications link (e.g., 133) with the device (e.g., device 110) and transmit revised device error codes to the device.

Data representing one or more device error codes logged at the stage 206 may be stored in memory or some other data store. For example, logged device error codes may be stored in a non-volatile memory and may be accumulated in the non-volatile memory until a specific period of time has elapsed, until a number of device error code entries have accumulated, or until a signal or other trigger is generated, for example. For example, accumulated device error codes may be communicated (e.g., transmitted via a wired and/or wireless communications link) to an external device or system in response to a power-up trigger (e.g., the device is turned on or awaken from a sleep or standby state), in response to a re-boot of the device, in response to the device being coupled with a charger (e.g., to replenish a re-chargeable battery), in response to the device establishing a communications link with another device (e.g., a wired and/or wireless communications link), in response to a data download from the device (e.g., to a data store, a memory device, an account associated with the device, a web site, the Internet, the Cloud, or an external device) of other data (e.g., activity tracking data, step data from walking or running, caloric intake/output data, dietary data, geolocation data, etc.), just to name a few.

At a stage 208, a determination may be made as to whether or not to transmit (e.g., communicate to another device or system) data representing one or more device error codes that were logged at the stage 204. If a NO branch is taken from the stage 208, then flow 200 may transition to another stage, such as back to the stage 204, for example. If a YES branch is taken from the stage 208, then flow 200 may transition to a stage 210.

At the stage 210, the device may establish (if not already established) a communications link (e.g., 131, 133) with an external device and/or system (e.g., a server, a backend system, a Cloud based system, the Internet, etc.). The communications link may be a wireless communications link, a wired communications link, or both. The wired communications link may include connecting a cable between the device (e.g., device 110) and the external system and/or device (e.g., using a USB cable, an Ethernet cable, a sync cable, a Lightning cable, a Thunderbolt cable, a FireWire cable, etc.). The wireless communications link may include a Bluetooth paring between the device and the external device and/or system, connecting via a wireless network (e.g., a WiFi network, WiMAX network, wireless access point) using access credentials (if needed), connecting with a cellular network (e.g., 3G, 4G or other), connecting using NFC, an optical link (e.g., an IR LED, a LED), an acoustic link (e.g., via a speaker or other transducer), just to name a few, for example. In some examples, the device and the external system may already be in communication with each other using a wired and/or wireless communications link and the stage 210 may be bypassed. After the communications link has been established, flow 200 may transition from the stage 210 to another stage, such as a stage 212.

At the stage 212, data representing device error codes that have been logged by the device may be transmitted to an external system and/or device (e.g., 150 and/or 190). The external system and/or device may process and/or analyze the data representing the device error code(s). On the other hand, the external system (e.g., system one) may communicate the data representing the device error code(s) to another system (e.g., system two) for processing and analysis. As one example, when the device transmits the data representing the device error codes to a single system (e.g., system one), then system one may be a server or other type of compute engine that receives the transmitted data representing the device error code(s) from the device.

As another example, when more than one system receives data representing the device error codes (e.g., system one and system two), then system one may include a client device (e.g., a smartphone, a smart watch, a tablet, a pad, a laptop, or a PC, etc.). The data representing the device error code(s) in the device may be transmitted to the client device and the client device may subsequently uses a communications link to transmit the data representing the device error code(s) to system two (e.g., a server, a backend system, etc.). The communications link between the device and the client device may be the same or may be different than the communications link between the client device and system two (e.g., a BT link between the device and the client device, and a cellular link between the client device and system two). After stage 212, flow 200 may transition to another stage, such as a stage 214.

At the stage 214 a determination may be made as to whether or not to continue logging errors on the device (e.g., device 110). If a NO branch is taken from the stage 214, then flow 200 may terminate. On the other hand, if a YES branch is taken from the stage 214, then flow 200 may transition to another stage, such as back to the stage 204, for example.

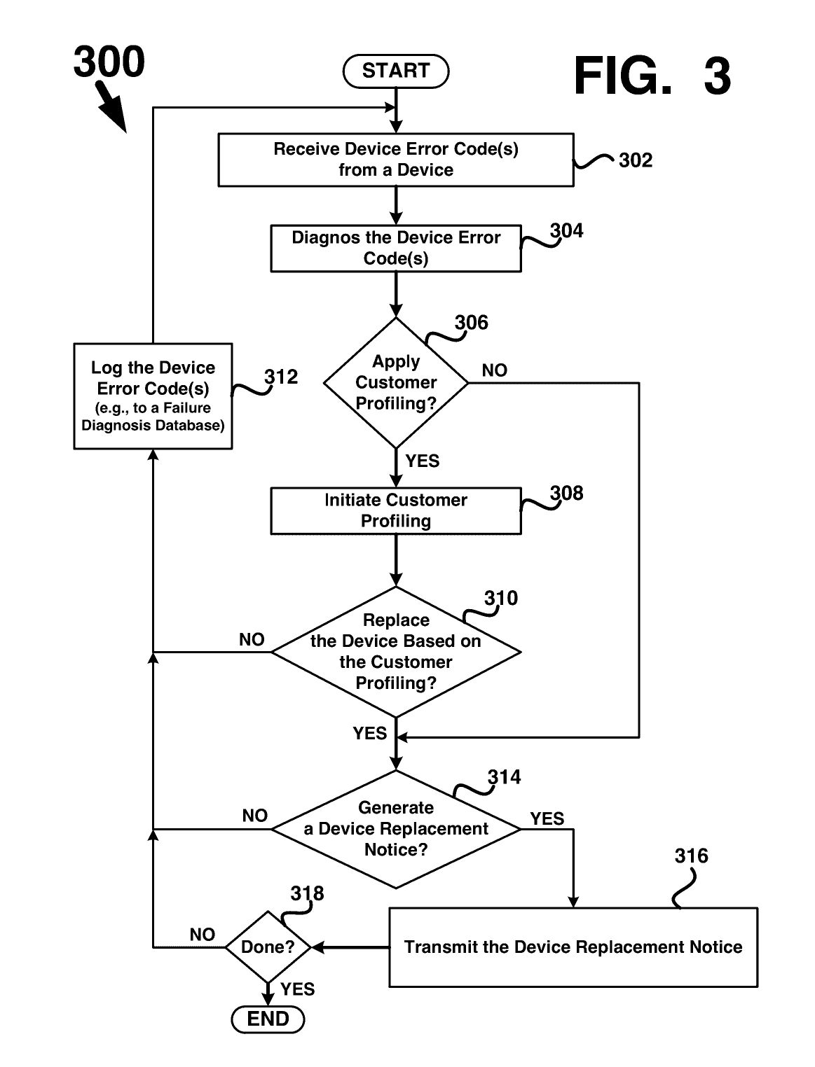

FIG. 3 depicts one example of a flow diagram 300 to receive data representing device error codes (e.g., from device 110 or from device 150) and to determine whether or not to replace a device (e.g., device 110). At a stage 302, a system (e.g., server 195 of backend system 190), may receive data representing one or more device error codes (e.g., transmitted at the stage 212 of flow 200). Hereinafter, the system or computer resource that receives and analyzes the data representing the device error code(s) will be denoted as the backend system regardless of whether or not the backend system receives the device error code(s) from a communication transmitted by the device (e.g., device 110) or from an intermediate device, such as a client device that the device is in communication with (e.g., device 150). The data representing the one or more device error codes received at the stage 302 may be stored in a data store (e.g., data store 197) accessible by the backend system. Stored data representing the device error codes may be processed in some order, such as in the order received, in a first-in-first-out (FIFO) basis, or may be stored and then processed from the data store at a later time. Data representing device error codes may be processed based on a type of device error code (e.g., ERR 5 or ERR 8) or based on a type or types of devices the data representing the device error codes were received from (e.g., a data capable strapband, a wireless media device, a wireless speaker box, a headset, a wearable device, a health and fitness monitoring device, etc.). The data store may include but is not limited to a hard disc drive (HD), a solid state drive (SSD), NAS, non-volatile memory (e.g., Flash memory), DRAM, SRAM, ROM, volatile memory, system memory, etc., just to name a few, for example.

At a stage 304 the data representing the one or more device error codes may be diagnosed by a computing device or compute engine (e.g., server 197 of FIG. 1). Diagnosis of the data representing the device error code(s) may occur as the data is received (e.g., in real time or in near real-time) or with a time delay (e.g., the data representing the device error code(s) may be diagnosed every six hours or at some other time interval). Diagnosis at the stage 304 may include hardware, software or both configured to determine whether or not the data representing the one or more of the device error codes for the device, received at the stage 302, are indicative of a defective device. Diagnosis that indicates the device is defective may not necessarily result in the device being replaced. Data accessed from a failure diagnosis database that includes data from previously diagnosed devices (e.g., other defective devices returned by customers to the manufacturer of the devices) may be used as part of the diagnosis at the stage 304. For example, the failure diagnosis database may include data representing a severity of device error codes associated with defective devices, a likelihood that a device will fail based on device error codes from previously diagnosed devices, etc., just to name a few. The failure diagnosis database may be updated as necessary to add new data, to improve accuracy of diagnosis, to add and/or remove device error codes, and to add data for newly introduced devices, etc., for example.

As one example, a software glitch, error, bug or the like may manifest itself as a hardware failure that triggers generation of data representing a hardware-related device error code. Diagnosis at the stage 304 may include accessing the failure diagnosis database using the received device error code as a look-up or search key, for example, and determine that identical or similar devices with the same device error code were not replaced because a root cause of the device error code was related to a software issue rather than a hardware issue, and the software issue may be fixed by a software update instead of device replacement. As another example, diagnosis at the stage 304 may include accessing the failure diagnosis database and determining that the device error code received is associated with a low battery reserve condition on previously diagnosed devices (e.g., the device error code was due to low battery power instead of an actual hardware failure). Accordingly, instead of replacing the device, a message may be communicated to the device (e.g., 110 or 150) instructing a user (e.g., customer 101) to charge the battery of their device using a wall charger or the like.

Prior to a determination that a device requires replacement, factors other than device error codes may be used in a calculus for computing (e.g., using server 197) whether or not to replace a device. At a stage 306, a determination may be made as to whether or not to apply customer profiling (e.g., using customer profile data accessed by a compute engine from a data store). If a NO branch is taken from the stage 306, then flow 300 may transition to another stage, such as a stage 314. If a YES branch is taken from the stage 306, then flow 300 may transition to a stage 308.

At the stage 308, data representing a customer profile may be accessed. The data representing the customer profile may be based, at least in part, on specific information on a customer (e.g., 101) whose device (e.g., 110) communicated the data representing the device error code(s) received at the stage 302. In other examples, the data representing the customer profile may be based, at least in part, on a class or group of customers. The data representing the customer profile for the class or group may be anonymized data that does not include information that may reveal the identities or other personal information on the persons included in the class or group. The data representing the customer profile for the class or group may be used to determine if the device reporting the device error codes should or should not be replaced based on what action was taken for device error codes for devices of customers in the class or group.

The data representing the customer profile may be used to determine (e.g., using hardware and/or software) a likelihood that a customer may call customer service to resolve an issue or issues pertaining to the customer's device. A customer who is likely (e.g., greater than 50%) to call customer service to resolve issues they are having with their device may be a candidate for device replacement. The data representing the customer profile may include information on past customer service contacts by the customer for the device (e.g., 110) and/or other devices that may be a different type of device. The data representing the customer profile may include information on how long (e.g., elapsed time in minutes) the customer interacted with customer service. For example, if customer service contacts (e.g., a phone call or Internet chat) are billed to a manufacturer of the device on a cost per unit of time basis, then past customer service contacts that were lengthy (e.g., several minutes or more) may be indicative of how much future customer service contacts may cost the manufacture. Accordingly, if the data representing the customer profile indicates a history of lengthy customer service contacts, then it may be financially advantageous to replace the customer's device before the customer attempts to contact customer service.

At a stage 310, a determination may be made as to whether or not to replace the device based on the customer profiling at the stage 308. If a YES branch is taken from stage 310, then flow 300 may transition to another stage, such as a stage 314. On the other hand, if a NO branch is taken from the stage 310, then flow 300 may transition to another stage, such as a stage 312.

At the stage 312, the one or more device error codes received at the stage 302 may be logged into a database (e.g., the failure diagnosis database). As one example, the database may be the failure diagnosis database and that database may be used for future iterations of flow 300. Data from device error codes in the database may be processed (e.g., using statistical analysis or other) to determine trends in device failures that may be used to earmark specific devices for replacement based on received device error codes, customer profiles or both. The database may be used for other purposes and is not limited to the examples described herein.

At the stage 314 a determination may be made as to whether or not to generate data representing a device replacement notice (e.g., an electronic message) for the device. If a NO branch is taken from the stage 314, then flow 300 may transition to another stage, such as back to the stage 312, for example. If a YES branch is taken from the stage 314, then flow 300 may transition to another stage, such as a stage 316, for example.

At the stage 316 one or more device replacement notices may be transmitted to a customer (e.g., the customer with the failed device). The device replacement notices may include an electronic message (e.g., an email, a text, a SMS, an instant message (IM), a tweet, a phone call and/or voice mail, a hyperlink included in an electronic message, a URI or URL included in an electronic message), just to name a few, for example. In other examples, the device replacement notice may include a mailing (e.g., postal mail, USPS, FedEx, UPS, DHL or other courier) that is delivered to an address of the customer. Backend system 190 may generate data that causes the mailing to be printed and mailed to the customer, for example.

Stage 316 may transition to a stage 318 where a determination may be made as to whether or not flow 300 is done (e.g., no more device error codes are being received). If a NO branch is taken from the stage 318, then flow 300 may transition to another stage, such as back to the stage 312, for example. If a YES branch is taken from the stage 318, then flow 300 may terminate.

At the stage 316, communicating data representing the device replacement notice to the customer may operate to prevent the customer from calling customer service to resolve a problem the customer may be having with the device and thereby reduce costs associated with a call to customer service (e.g., billing the cost on a per minute basis or some other basis). The data representing the device replacement notice may notify the customer that one or more problems have been detected with their current device and provide the customer with instructions for obtaining a replacement device. The data representing the device replacement notice may optionally include instructions for returning the defective device (e.g., returning the defective device to the manufacture for failure diagnosis). In some examples, a customer may have on file a communications preferences (e.g., from registering the device with the manufacturer) such as email addresses, phone numbers, postal address, shipping address, Twitter handle, or some other address were communications may be received. A customer preference database may include preferences for the customer and may be accessed (e.g., by server 197) at the stage 316.

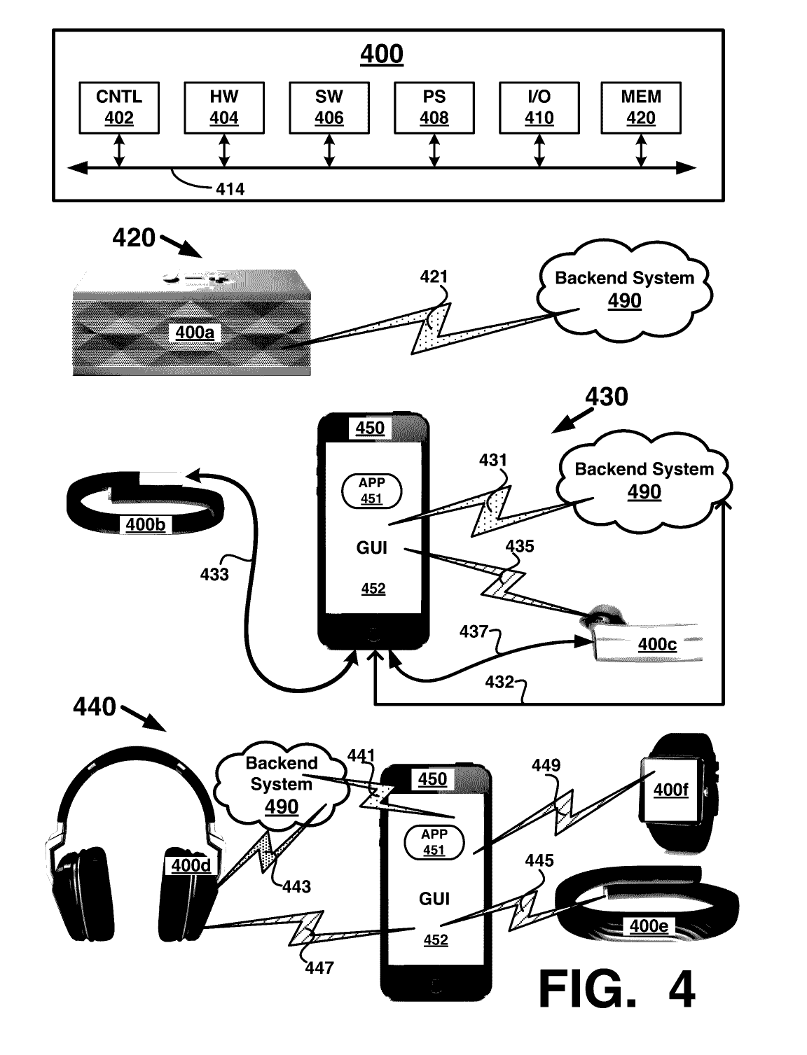

Attention is now directed to FIG. 4 where examples of devices communicating logged errors to external devices are depicted. A device 400 (e.g., a customer's device that logs device error codes) may include a controller CNTL 402 (e.g., a processor, compute engine, CPU, controller, ASIC, DSP, FPGA, μC, μP, etc.), hardware HW 404 (e.g., circuitry, data storage, transducers, a display, sensors, biometric sensors, bioimpedance sensors, optical sensors, temperature sensors, motion sensors, accelerometers, MEMS devices, communication ports, mechanical components, electrical components, etc.), software SW 406 (e.g., an operating system (OS), BIOS, firmware, error logging algorithm 121, boot code, data base, look-up-table, hash table, etc.), a power supply PS 408 (e.g., a battery, a rechargeable battery, an AC power source, a DC power source, an AC-to-DC power source, etc.), an input/output unit I/O 410 (e.g., a RF system with one or more radios for wireless communications using one or more protocols, hardwired communications, communications with other systems in device 400, etc.), and memory MEM 412 (e.g., non-volatile memory). MEM 412 may include data that may be used in the error logging process. The data may include but is not limited to addresses, access credentials or other data that may be necessary for establishing communications links with external devices and/or systems (e.g., at the stage 210 in flow 200 of FIG. 2). The data may include data representing one or more device error codes logged by error logging algorithm 121 and the data representing the one or more device error codes. One or more of the blocks 402-412 in device 400 may be in communications with each other via a bus 414. Blocks 402-412 may generate signals, triggers or data indicative of a failure (e.g., a hardware failure, a software failure) that are logged (e.g., by error logging algorithm 121). As one example, PS 408 may be a rechargeable battery (e.g., a lithium ion type rechargeable battery) and circuitry and/or software that monitors performance, charge state, charge time, discharge time and other battery parameters may detect that PS 408 is failing to hold a full charge after being recharged for a time that ought to result in a fully recharged battery. A signal generated by circuitry that monitors PS 408 (e.g., power watch dog circuitry coupled with PS 408) may be received by CNTL 402 and passed as data to the error logging algorithm 121, which in turn may log the appropriate device error code, such as “ERR 17; Battery Charge Failure; 07/24/2014; 02:25:17; AM; PST”, for example. The data representing the logged error code may be transmitted to an external device (e.g., via I/O 410) in real time, in near real-time or may be transmitted at a later time.

Moving now to example 420 of FIG. 4, where a device 400a (e.g., a wireless speaker box) and a backend system 490 are in communication with each other via a wireless link 421 (e.g., a link established at the stage 210 of flow 200 of FIG. 2). Wireless link 421 may be established through another wireless system, such as a wireless access point, a wireless router or cellular network, for example. Device 400a may transmit data representing logged device error codes to backend system 490 as they occur or may accumulate one or more logged device error codes (e.g., in MEM 412) and then transmit the accumulated device error code(s) at some future time (e.g., a day later), at some predetermined time (e.g., at 2:00 AM if there are logged device error codes in memory) or at a predetermined time interval (e.g., every 12 hours). Logged device error codes communicated over the link 421 may be included in data packets or other format. Logged device error codes may be encrypted and backend system 490 may include a key for decrypting the encrypted device error codes. Error-correcting code (ECC), hash code, compression or other manipulations of digital data may be applied to the data representing the device error codes (e.g., by SW 406 or by APP 151, APP 451). For example, a hashing function may be applied to the data representing the device error codes.

Moving down to example 430, where two devices, 400b (e.g., a wearable health/fitness/activity monitor) and 400c (e.g., a wireless headset) are depicted in communication with a client device 450 (e.g., a smartphone, a tablet, a pad, etc.). Device 400b may be configured (e.g., via I/O 410) for wired communications with external devices or systems. Here, a hard wired connection 433 (e.g., a cable) may be coupled between a communications port on device 400b (e.g., a micro-USB connector) and a communications port on client device 450 (e.g., a USB or sync port). Device 400c may be configured (e.g., via I/O 410) for both wired 437 and wireless 435 communications with client device 450. Wired communications 437 may be established in a manner similar to that described above for device 400b. Wireless communications 435 may use one or more radios in device 400c (e.g., BT, BTLE, NFC, WiFi, etc.) to communicate with one or more radios in client device 450. Logged device error codes communicated over the links (433, 437, 435) may be received by client device 450 and may be communicated by the client device 450 to the backend system 490 via wireless communications link 431 (e.g., via WiFi, WiMAX, Cellular, etc.). An application (APP) 451 executing on a processing unit of client device 450 may operate to re-transmit received device error codes from one or more devices (e.g., 400b, 400c, or both) to backend system 490. Data representing device error codes received by client device 450 may be encrypted (e.g., by APP 451) prior to communicating the device error codes to backend system 490). APP 451 may present menus, icons, images or other data on a display 452 of client device 450. APP 451 may be presented by a graphical user interface (GUI) on display 452 of client device 450. Client device 450 may communicate device error codes to backend system 490 using another wireless system (e.g., a wireless router, cellular network, etc.). Client device 450 may communicate device error codes to backend system 490 using a wired link 432 (e.g., Ethernet, LAN, USB, sync port, etc.) and the wired link may communicate with backend system 450 using another system (e.g., a router). APP 451 may be installed or otherwise downloaded to client device 450 from a location such as an application store (e.g., the App Store, the Play Store, etc.), a website, etc. In some examples, APP 451 may execute unnoticed (e.g., in a background mode) by a user of client device 450 (e.g., by the customer who owns device 400b and/or 400c).

In example 440, three devices, 400d, 400e and 400f may wirelessly link (447, 445, 449) with client device 450 and the wireless links (447, 445, 449) may use the same or different wireless communications protocols. However, device 400d may also be configured to wirelessly link 443 with backend system 490. In some examples, when device 400d is not within wireless communication range of client device 450, device 400d may instead establish the wireless link 443 with backend system to communicate logged device error codes. In other examples, when device 400d is within wireless communication range of client device 450, then link 447 is established for communication of logged device error codes. Devices 400e (e.g., a data capable strap band) and 400f (e.g., a smart watch) may be wirelessly linked with client device 450 by operation of a previous paring (e.g., BT paring) or linking with client device 450. Device 400d may use the same or different wireless communications protocols for communications between client device 450 and backend system 490.

APP 451 may operate to receive the data representing the device error codes from one or more devices (e.g., customer devices) and re-transmit the data representing the device error codes to the backend system 490. In other examples, APP 451 may operate to encrypt the data representing the device error codes (even if previously encrypted by the device(s) that transmitted them) prior to communicating the now encrypted data representing the device error codes to the backend system 490. Client device 450 may communicate the data representing the device error codes to the backend system using a data format including but not limited to packets or other data formats.

Examples 430 and 440 depict two or more devices (e.g., a customer having multiple devices) that may log device error codes and communicate those device error codes with client device 450 and/or with backend system 490. Device error codes for each device that are communicated to client device 450 may be separately logged and stored in different memory locations prior to communicating the logged device error codes for each device to the backend system 490. Software (e.g., APP 451, SW 406), hardware (e.g., CNTL 402, HW 404, I/O 410) or both may be configured to arbitrate between each device and client device 450 to handle potential conflicts that may arise when multiple devices attempt to communicate their logged device error codes to the client device 450. For example, devices 404e and 404f may communicate data representing the device error codes at the same time to client device 450 and client device 450 may communicate a signal or handshake to device 400f that commands device 400f to wait for a another signal or handshake to commence transmitting its data representing the device error codes. While device 400f is waiting, device 400e may transmit the data representing the device error codes to the client device 450. In some examples, client device 450 may include hardware and/or software resources to handle communications from multiple devices at the same time, such as using different radios for wireless communications with different devices and/or using wired and wireless links for communicating with different devices. In other examples, backend system 490 may arbitrate receiving logged device error codes from multiple devices and/or multiple client devices. In yet another example, backend system 490 may include resources configured to handle receiving multiple communications of logged device error codes from multiple devices and/or multiple client devices.

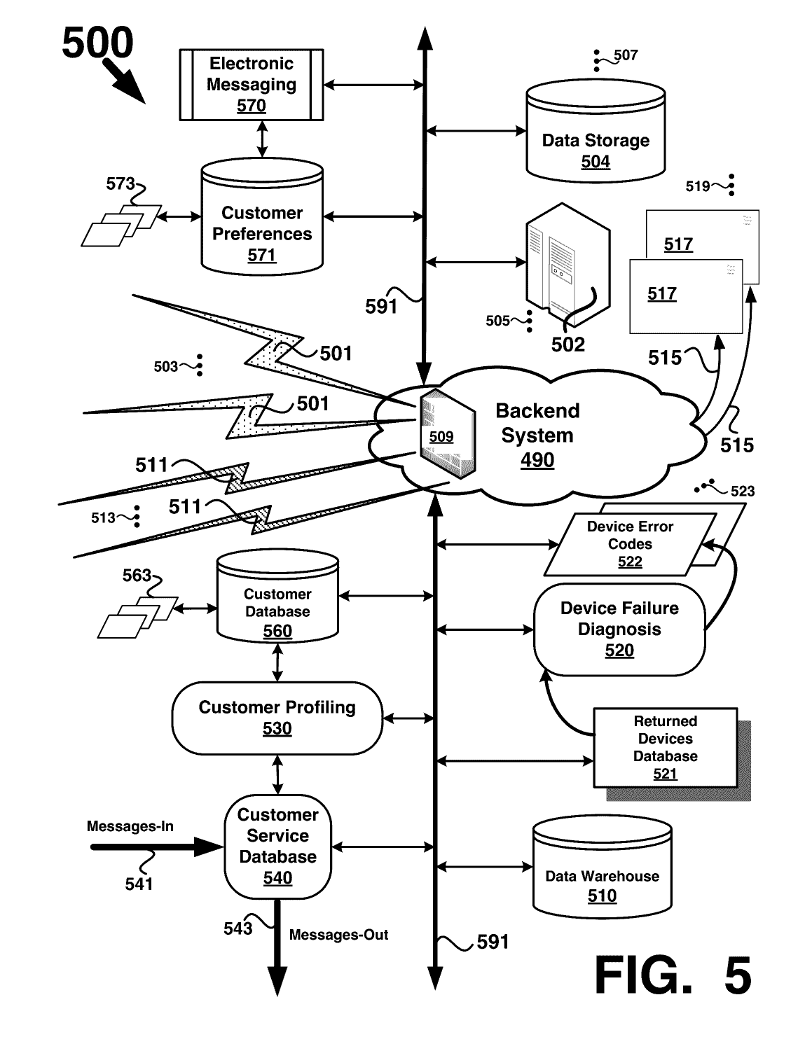

Reference is now made to FIG. 5 where one example 500 of a backend system. A backend system 490 may receive one or more communications 501 that include data representing device error codes transmitted by one or more devices (e.g., 110, 150, 400, 400a-400f, 450). Backend system 490 may receive more of fewer communications 501 than depicted as denoted by 503. Backend system 490 may have access via a network 591 to a variety of resources that may be internal to backend system 490, external to backend system 490 or both. Communication between networked resources may be by wired and/or wireless communications over network 591. Backend system 490 may include a firewall 509 for data security and/or to restrict access to one or more of the networked resources. Backend system 490 may access one or more networked resources including but not limited to compute engine 502, data storage 504, device failure diagnosis 520, device error codes 522, returned devices database 521, data warehouse 510, customer service database 540, customer profiling 530, and customer database 560. Device failure diagnosis 520 and/or customer profiling 530 may be modules (e.g., implemented in hardware, software or both) that may be accessed by backend system 490 as part of the calculus in determining whether or not to replace a device. The network resources may communicate with backend system 490 and one another using wired and/or wireless communications. Compute engine 502 may include but is not limited to one or more servers, mainframes, laptops or PC's. In some examples, there may be more compute engines than depicted as denoted by 505. Compute engine 502 may execute one or more stages of flow 300 of FIG. 3, for example. Data storage 504 may be accessed by compute engine 502 and other resources via network 591. Data storage 504 may include but is not limited to non-volatile memory, volatile memory, Flash memory, HDD, SSD, RAID, NAS or other forms of data storage, just to name a few, for example. In some examples, data storage 504 may include more units than depicted as denoted by 507. Data storage 504 may include information that may be accessed for read, write or both by compute engine 502 and/or other of the networked resources via network 591.

In some examples, backend system 490 may receive 501 device error codes and perform analysis (e.g., according to one or more stages of flow 300) to determine if a particular device should be replaced based one or more of the data representing the device error codes, results from customer profiling 530, results from customer service data base 540, and communicate (e.g., based on customer preferences 571 or other data) an appropriate message (e.g., electronic or non-electronic) to notify the customer of an offer to replace their device.

Device failure diagnosis 520 may analyze data accessed from returned devices database 521 (e.g., data on defective devices returned to the manufacturer) to determine causes of failures and may create device error codes 522 that are included in and/or are accessible by an error logging algorithm (e.g., 121) for logging error codes in a device (e.g., 110 of FIG. 1 or 400, 400a-400f of FIG. 4). Device error codes may include device error codes that may be shared among devices, device error codes that are device specific, or both. Device failure diagnosis 520 may be an iterative process where data on each batch of returned devices accessed from returned devices database 521 are diagnosed. The diagnosis may yield new failure modes, may re-confirm already known failure modes, may alter an importance placed on certain failure modes, and that information may be used to update device error codes 522 as denoted by 523. Device error codes included in the device error codes 522 or other location (e.g., data warehouse 510) may be accessed by backend system 490 during one or more stages of flow 300, such as at the stage 304 where device error codes received 501 by the backend system 490 at the stage 302 are diagnosed (e.g., by compute engine 502) at the stage 304. Data warehouse 510 may include a copy or a version of the device error codes 522 for access by other systems via network 591, including but not limited to customer profiling 530, customer service database 540, and backend system 490, for example.

Customer database 560 may include information about customers and their device(s), including but not limited to customer name, postal/residence address, phone numbers, mobile phone numbers, contact information (e.g., email addresses, customer contact preferences, social and/or professional media address—Twitter handle, Facebook, etc.), device serial number, device model number, device purchase data, device seller (e.g., retail source, Internet source, etc.), customer demographic information, number of customer calls to customer service, number of calls from customer service to the customer, identify customers who have seeded devices, customer profiles, customer device use profiles, customer device purchase history, etc., just to name a few. Customer database 560 may include a profile for each customer (e.g., a customer profile) that may be analyzed as described above in reference to stages 306-314 of flow 300 in order to determine, along with other factors (e.g., received device error codes), whether or not to replace a device for which logged device error codes have been received (e.g., 501) by backend system 490. Customer database 560 may include data representing anonymized customer profiles 563. The data representing the anonymized customer profiles 563 may be used in determining whether or not to generate a device replacement notice, based at least in part, on what action was taken for other customers from whom the anonymized was collected. For example, if data representing the anonymized customer profiles 563 indicates that anonymized customers with devices identical to the customer's device and that transmitted identical device error codes had device replacement notice generated for their devices, then that data may be used to determine that the customer's device warrants replacement.

Customer profiling 530 may access various resources on network 591 and may provide data to backend system 490 that may be used by the backend system 490 to determine whether or not to replace a device based on its diagnosis of received device error codes and/or customer profile as described above in reference to flow 300 of FIG. 3. Customer profiling 530 may access data from various resources on network 591 and use that data to determine the likelihood that a customer may call customer service when that customer is having problems with their device(s). For example, a likelihood that a customer may call or otherwise contact customer service may be ranked from 0 to 1, with 1 being 100% likelihood the customer will contact customer service 540 and 0 being 0% likelihood the customer will contact customer service 540. Even though the likelihood is greater than 50% (e.g., >0.5) or is less than 50% (e.g., <0.5), a determination to replace the device may still be made in the affirmative based on one or more other factors. Customer profiling 530 may access data representing customer service contacts (e.g., the number of times the customer has contacted customer service by phone, web site, email, etc.) for a customer (e.g., 101) from the customer service database 540. A device replacement notice may be generated if the data representing the customer service contacts exceeds a threshold number (e.g., 3 or more contacts with customer service).

Customer profiling 530 may determine a cost/benefit of proactively monitoring devices for device error codes and optionally offering customers a replacement device, versus having those customers contact customer service and the concomitant costs associated with customer contacts with a customer service department. Customer profiling 530 may also monitor data from customer database 560 and may use that data to determine if a device should be replaced based on a customer's profile (e.g., customers of seeded devices, high value customers, etc.). As one example, a journalist in technology may have received a seed device for review. Data representing device error codes from the seed device may automatically generate a device replacement notice. Data representing device error codes received from a device of a customer who has a history (e.g., as accessed from customer database 560) of purchasing many devices from the manufacture may automatically receive a device replacement notice to foster good will between the customer and the manufacturer, for example.

Backend system 490, upon determining that a device ought to be replaced, may access customer preferences 571 to determine a preferred mode of contact for the customer of the device. If the mode of contact is by one or more forms of electronic messaging, then electronic messaging 570 may be activated to generate an electronic message to be communicated 511 to the customer (e.g., in a format(s) specified in customer preferences 571). Backend system may communicate 511 more or fewer electronic messages than depicted as denoted by 513. As one example, customer-A may prefer email sent to an email address stored in 571 and/or 560, customer-B may prefer a tweet to a Twitter handle address stored in 571 and/or 560, and customer-C may prefer a text message sent to a mobile phone number stored in 571 and/or 560. The above examples of electronic messages are non-limiting and other types of electronic messages may be generated by backend system 490. Customer preferences 571 may include data representing anonymized customer preferences 573. The data representing the anonymized customer preferences 573 may be used to determine, at least in part, whether or not to generate a device replacement notice based on preferences of a larger group or pool of customers. For example, if customer-A has no contact preference for receiving a device replacement notice, then data representing the anonymized customer preferences 573 may be analyzed to determine the most preferred contact preference for the larger group or pool of customers (e.g., via text, email, Tweet, etc.). If customer-A has an email address and the data representing the anonymized customer preferences 573 indicates that email is a preferred contact preference for the larger group or pool of customers, then the device replacement notice may be emailed to the customer-A.

In some examples, a customer may prefer a non-electronic form of contact and that preference may be included in customer preferences 571. To that end, backend system 490 may generate 515 a mailing 517 to notify the customer that their device needs to be replaced. Examples of mailing 517 may include but are not limited to postal mail, USPS mail, DHL, FedEx, UPS, or other carrier, just to name a few. There may be more or fewer mailings 517 generated 515 by backend system 490 as denoted by 519. In other examples, a customer may prefer a phone call and that preference may be included in customer preferences 571. Customer service 540 may call the customer (e.g., Calls-Out 543) to inform them that their device is in need of replacement. In yet other examples, Customer service 540 may call or contact the customer through one or more different types of communication when a customer has not responded to a prior notice of device replacement (e.g., after two weeks have passed).

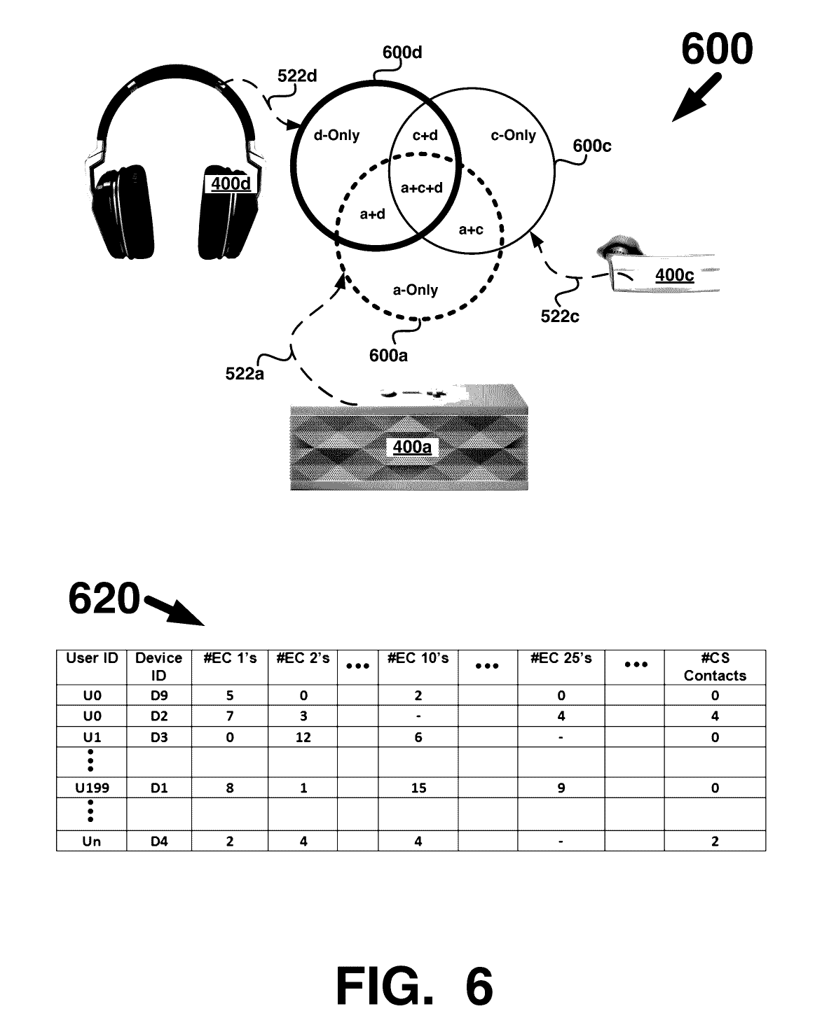

Turning now to FIG. 6 where a diagram 600 of device error codes and a table 620 of data that may be used as part of a device replacement determination are depicted. In diagram 600, the three devices (400a, 400c, and 400d) may have different capabilities and may have differences in hardware and/or software systems to implement those capabilities. However, each device may have device error codes and some of those device error codes may be different than those on the other devices or some of those device error codes may be the same as those on the other devices. Device 400a (e.g., a wireless speaker box) has device error codes 522a denoted by dashed circle 600a, device 400c (e.g., a wireless headset) has device error codes 522c denoted by circle 600c, and device 400d (e.g., wireless over-the-head headphones) has device error codes 522d as denoted by heavy lined circle 600d. Device error codes 522a that are exclusive to device 400a are denoted in an a-Only region, device error codes 522c that are exclusive to device 400c are denoted in an c-Only region, and device error codes 522d that are exclusive to device 400d are denoted in an d-Only region. On the other hand, device error codes that are common to two or more of the devices are denoted in the overlapping regions as a+c, a+d, c+d and a+c+d. For example, if all three devices include rechargeable batteries, then the above mentioned “ERR 17; Battery Charge Failure” may be the device error code that is common to all three devices (e.g., a+c+d). On the other hand, device error code “ERR 37; Left Earpiece Amplifier Failure” may be exclusive to device 400d (e.g., d-Only) as that device includes left and right earpieces of an over-the-head headphone, for example.

In table 620, data including but not limited to: data identifying each customer (User ID), data identifying a device type (Device ID) for each device a customer has registered (e.g., with a manufacturer of the device); data identifying the number of instances (#EC) a logged error has been received by the backend system; and a number of times (#CS Contacts) the customer has contacted customer service. The #CS Contacts need not be related to a problem the customer is having with their device. Data including but not limited to User ID and Device ID may be derived from other data and/or databases, such as a database having information on customers who register their devices and as part of the registration process, the customer may enter device information, personal information, etc. Examples of information a customer may register include but are not limited to device serial number, device model number, date of purchase, where device was purchased (e.g., brick-and-mortar retailer, on-line seller, gift, etc.), and purchase price, just to name a few. Registration data may be stored in one or more of the networked resources of backend system 490 (e.g., 504, 510, 560, 571).

Table 620 may be stored in one or more of the networked resources of backend system 490, such as in data warehouse 510, for example. Table 620 may be accessed by various networked resources depicted in FIG. 5. Those networked resources may access table 620 as part of the determination as to whether or not to replace a device. Furthermore, resources in FIG. 5 may update, amend, remove or otherwise operate on data included in table 620. For example, backend system 490 may update (e.g., increment) device error code #EC 1 from 0 to 1 based on a recently received 501 device error codes logged by Device D3 of customer U1. The customer service database 540 may be accessed to change the #CS Contacts from 0 to 1 for customer U1 based on customer U1 calling customer service (e.g., Calls-In 541). Threshold values for the number of customer service contacts and/or number of device error code instances, when exceed, may be used to determine whether or not to generate and/or transmit a device replacement notice. For example if a device error code has 20 instances in table 620 and that exceeds a threshold of 10 instances, then a device replacement notice may be generated due to the threshold value being exceeded.

Referring back to flow 300 of FIG. 3, backend system 490 may access resources including but not limited to customer profiling 530, data warehouse 510, table 620 and device failure diagnosis 520 to determine whether or not to replace a customer's device at the stage 310 based on determinations from prior stages 304 and/or 308. As one example, at the stage 306, the NO branch may be taken to the stage 314 because at the stage 304, diagnosis of the device error codes indicates replacement of the device is warranted and there is no need to initiate customer profiling at the stage 308. Accordingly, when diagnosis of device error codes calls for device replacement, the stage 308 may be bypassed by taking the NO branch to the stage 314. Device failure diagnosis 520 may tag certain device error codes (e.g., as data stored in data warehouse 510) as being serious enough to warrant device replacement, such that in flow 300, the stage 308 may be bypassed as described above. As one example, in table 620, fifteen (15) #EC 10's for device ID D1 for customer U199 may trigger replacement of device D1 due to the number of #EC 10's exceeding a predetermined number (e.g., ≧6). Similarly, device D3 of customer U1 requires replacement due to twelve (12) #EC 2's being logged for that device and 12 exceeds a maximum number of allowed errors of 5 for device error code EC 2. Device failure diagnosis 520 may use data from prior diagnosis of data accessed from returned devices database 521 to determine that device types D1 and D3 in the above example should be replaced due to the number of logged device error codes for EC 10 and EC 2.

For example, in flow 300, if the YES branch is taken from the stage 306, then at the stage 308, customer profiling 530 may be initiated by backend system 490 and customer profile data may be accessed and analyzed. As one example, if a customer is likely to call customer service 540 when they are experiencing problems with their device, that tendency by the customer may be predictable based on prior calls that customer has made and stored as data representing the number of customer service contacts in customer service database 540. In table 620, customer U0 has made four prior customer service contacts (e.g., #CS Contacts 4). Customer profiling 530 may use statistical and/or other data that indicates a customer who has a number of customer service contacts in the past (e.g., X customer service contacts), is likely to contact customer service in the future if they are experiencing problems with their device. In table 620, device D2 for customer U0 has logged 7 EC 1's and 4 EC 25's, that data from table 620 along with the 4 prior customer service contacts may result in stage 310 taking the YES branch to stage 314 so that a replacement notification may be generated for customer U0.

In some examples, customer profiling at stage 308 may include backend system 490 accessing data from customer data base 560 and/or data warehouse 510 to determine if a customer's profile warrants device replacement based on the profile, based on the device error code diagnosis at the stage 306, or based on both. As one example, a device may be seeded with a customer who is a member of the press, an expert, a coach, a trainer, a professional athlete, a technology reviewer, a retailer, etc. It may be desirable to replace a seeded device when device error codes are logged for that device. In some instances, the seeded device may be replaced even if the logged device error codes do not indicate a major defect in the device (e.g., the device would not be replaced based on the device error codes that were received).

In some examples, a customer may have a history of repeat purchases of devices and analysis of that customer's profile may indicate that device error codes logged for the customer's device warrant replacing the device as a showing of good will towards a loyal customer. In other examples, regular activity that is indicative of a consistent pattern of customer interaction with the customer's device may be a basis for replacing that device based on logged device error codes. Activities that may indicate the consistent pattern of use include but are not limited to a customer logging (e.g., uploading to a web site) step data (e.g., from walking or running), exercise activity data, diet data, calories burned data, calories consumed data, accelerometry data (e.g., from motion sensors), biometric and/or bioimpedance data (e.g., of the sympathetic nervous system (SNS)), heart rate data, respiration data, playback and/or downloading of content (e.g., music, video, games, APP's, etc.), wireless communications activity between the device and other wireless devices (e.g., a smartphone table, pad, etc.), customer screen activity on another device in communication with the device (e.g., using an APP executing on a computing device to enter exercise/dieting information), customer click-through on emails or other forms of electronic messaging that are received from a manufacturer of the device (e.g., customer clicks a link, an image or a hyperlink in an email), syncing of data between the device and another device, just to name a few, for example.

In yet other examples, customer demographics may be used as part of the determination as to whether or not to replace a device based on demographic information about the customer and/or logged device error codes. For example, customers over the age of forty (40) may be more likely to continue to use a device even if the device is malfunctioning. In still other examples, a customer cohort (e.g., how long a customer has been using a device) may be used as part of the determination as to whether or not to replace a device.

In one example, a customer may be deemed a high retention customer. The high retention customer may be a high value customer due to prolific use of the device by that customer. However, the high retention customer may stop using the device if it is broken, may not call customer service, and may give up beneficial activates associated with use of the device (e.g., exercise, dieting, sleep monitoring, relaxing to music, etc.). Although the high retention customer is not apt to call customer service it may be desirable to retain the high value customer as an advocate for the device and/or the brand it represents by replacing the device upon detection of device error codes.

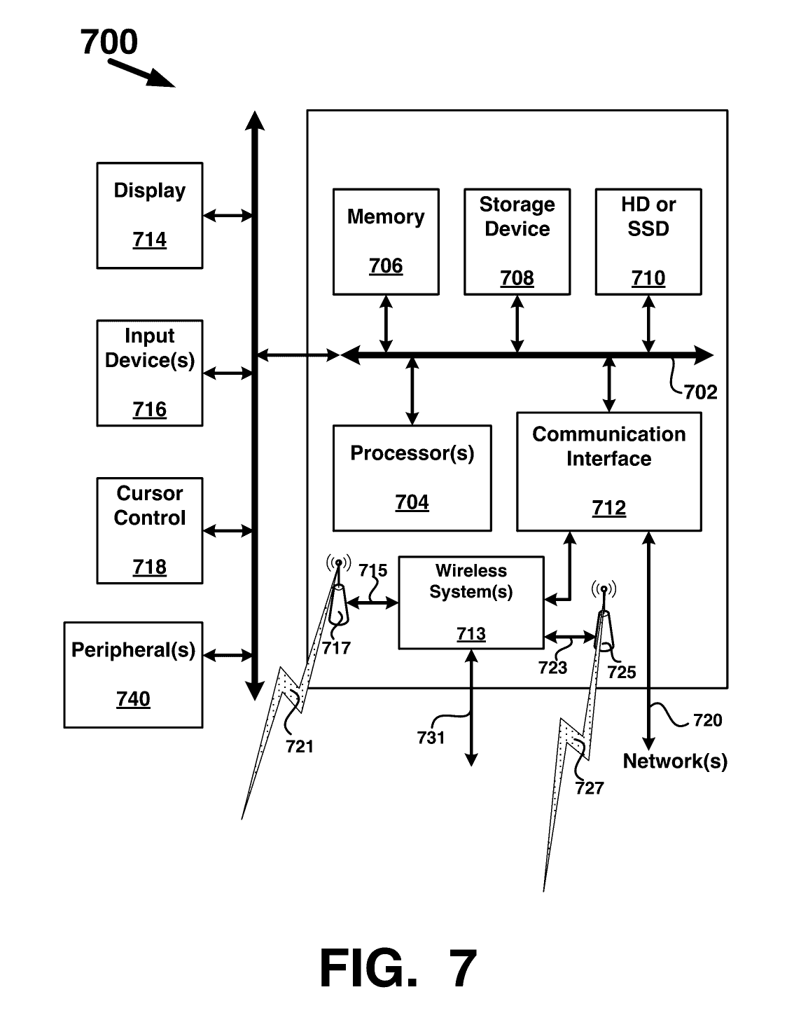

Turning now to FIG. 7 where one example of a computer system 700 is depicted. In some examples, computer system 700 may be used to implement circuitry, hardware, client devices, media devices, wireless devices, etc. Computer system 700 may be used to execute computer programs, applications (e.g., APP's), application programming interfaces (API's), configurations (e.g., CFG's), methods, and processes to perform the above-described techniques (e.g., execute machine readable instructions for of one or more stages of flow 200, flow 300). Computer system 700 may be used to implement a computing device, client device, server, a backend system, or the like as described above in reference to FIGS. 1, 4, 5 and 6, for example. Computer system 700 may include a bus 702 or other communication structure for communicating signals and/or information. Bus 702 may interconnect subsystems and devices, such as one or more processors 704, system memory 706 (e.g., RAM, SRAM, DRAM, Flash Memory), storage device 708 (e.g., Flash Memory, ROM), disk drive 710 (e.g., magnetic, optical, solid state), communication interface 712 (e.g., modem, Ethernet, USB, one or more varieties of IEEE 802.11, WiFi, WiMAX, WiFi Direct, Bluetooth, Bluetooth Low Energy, NFC, Ad Hoc WiFi, HackRF, software-defined radio (SDR), WAN or other), display 714 (e.g., CRT, LCD, OLED, touch screen), one or more input devices 716 (e.g., keyboard, stylus, touch screen display), cursor control 718 (e.g., mouse, trackball, stylus), one or more peripherals 740. Some of the elements depicted in computer system 700 may be optional, such as elements 714-718 and 740, for example and computer system 700 need not include all of the elements depicted. Computer system 700 may be networked (e.g., via wired 720 and/or wireless 721, 727 communications link) with other computer systems (not shown). Communications interface 712 may include an input/output (I/O) unit configured to transmit and/or receive signals and/or data from external sources (e.g., via 720, 731, 721, 727) and/or from internal sources of computer system 700 via bus 702, for example.

According to some examples, computer system 700 performs specific operations by processor 704 executing one or more sequences of one or more instructions stored in system memory 706. Such instructions may be read into system memory 706 from another non-transitory computer readable medium, such as storage device 708 or disk drive 710 (e.g., a HD or SSD). In some examples, circuitry may be used in place of or in combination with software instructions for implementation. The term “non-transitory computer readable medium” refers to any tangible medium that participates in providing instructions and/or data to processor 704 for execution. Such a medium may take many forms, including but not limited to, non-volatile media and volatile media. Non-volatile media includes, for example, Flash Memory, optical, magnetic, or solid state disks, such as disk drive 710. Volatile media includes dynamic memory (e.g., DRAM), such as system memory 706. Common forms of non-transitory computer readable media includes, for example, floppy disk, flexible disk, hard disk, non-volatile memory, Flash Memory, SSD, magnetic tape, any other magnetic medium, CD-ROM, DVD-ROM, Blu-Ray ROM, USB thumb drive, SD Card, any other optical medium, punch cards, paper tape, any other physical medium with patterns of holes, RAM, PROM, EPROM, FLASH-EPROM, any other memory chip or cartridge, or any other medium from which a computer may read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, wires that include bus 702 for transmitting a computer data signal. In some examples, execution of the sequences of instructions may be performed by a single computer system 700. According to some examples, two or more computer systems 700 coupled by communication link 720 (e.g., LAN, Ethernet, PSTN, USB, wireless network, WiFi, WiMAX, WiFi Direct, Bluetooth (BT), NFC, Ad Hoc WiFi, HackRF, software-defined radio (SDR), or other) may perform the sequence of instructions in coordination with one another. Computer system 700 may transmit and receive messages, data, and instructions, including programs, (e.g., application code), through communication link 720 and communication interface 712.

Received program code may be executed by processor 704 as it is received, and/or stored in a drive unit 710 (e.g., a SSD or HD) or other non-volatile storage for later execution. Computer system 700 may optionally include one or more wireless systems 713 (e.g., one or more radios) in communication with the communication interface 712 and coupled (715, 723) with one or more antennas (717, 725) for receiving and/or transmitting RF signals (721, 727), such as from a WiFi network, BT radio, or other wireless network and/or wireless devices, for example. Examples of wireless devices include but are not limited to: a data capable strap band, wristband, wristwatch, digital watch, or wireless activity monitoring and reporting device; a smartphone; cellular phone; a tablet; a tablet computer; a pad device; a touch screen device; a touch screen computer; a laptop computer; a personal computer; a server; a personal digital assistant (PDA); a portable gaming device; a mobile electronic device; and a wireless media device, just to name a few.

Computer system 700 in part or whole may be used to implement one or more systems, devices, or methods that communicate with one or more external devices (e.g., external devices that transmit and/or receive electronic messages, such as device error code(s)). Wireless systems 713 may be coupled 731 with an external system, such as an external antenna or a router, for example. Computer system 700 in part or whole may be used to implement a remote server, a networked computer, a client device, a host device, a media device, or other compute engine in communication with other systems or devices as described herein. Computer system 700 in part or whole may be included in a portable device such as a smartphone, laptop, client device, host device, tablet, or pad.

Although the foregoing examples have been described in some detail for purposes of clarity of understanding, the above-described inventive techniques are not limited to the details provided. There are many alternative ways of implementing the above-described techniques or the present application. The disclosed examples are illustrative and not restrictive.

What is claimed is:

1. A method, comprising:
receiving, on a general purpose computer, data representing a device error code;
diagnosing the data representing the device error code using the general purpose computer;
determining, using the general purpose computer, whether or not to replace a device based on the diagnosing;
generating data representing a device replacement notice for the device when the device is to be replaced; and
transmitting the data representing the device replacement notice to an account associated with the device.

2. The method of claim 1, wherein the data representing the device replacement notice constitutes data representing an electronic message.

3. The method of claim 1, wherein the data representing the device replacement notice is transmitted in accordance with data representing a preferred mode of contact accessed from a customer preference database by the general purpose computer.

4. The method of claim 1, wherein the determining further comprises the general purpose computer accessing data representing a customer profile.

5. The method of claim 4 and further comprising:
applying customer profiling to the data representing the customer profile to determine if a number of customer service contacts exceeds a threshold number, and causing the generating and the transmitting when the number of customer service contacts exceeds the threshold number.

6. The method of claim 4 and further comprising:
applying customer profiling to the data representing the customer profile to determine if the device constitutes a seeded device, and causing the generating and the transmitting when the device is a seeded device.

7. The method of claim 1 and further comprising:
accessing a data store including data representing a number of instances for the data representing the device error code, and causing the generating and the transmitting when the data representing the number of instances exceeds a threshold number.

8. A device, comprising:
A controller;
an input/output unit coupled with the controller; and
a memory coupled with the controller, the memory including an error logging algorithm having executable instructions fixed in a non-transitory computer readable medium,
the controller configured to execute instructions in the error logging algorithm to detect device error codes and to store in the memory, data representing device error codes that are detected,
the controller operative to cause the input/output unit to establish a communications link, and
the controller operative to cause the input/output unit to transmit the data representing the device error codes using the communications link.

9. The device of claim 8, wherein the communications link comprises a wireless communications link.

10. The device of claim 9, wherein the communications link is established with an external computing device.

11. The device of claim 8, wherein the controller is configured to accumulate the data representing device error codes in the memory and to transmit the data representing the device error codes, using the communications link, after a period of time has elapsed.

12. The device of claim 8, wherein the controller is configured to accumulate the data representing device error codes in the memory and to transmit the data representing the device error codes, using the communications link, after a number of device error codes have been accumulated in the memory.

13. The device of claim 10, wherein the device error codes that are communicated using the communications link are configured to be received by a backend system in data communication with one or more networked computing resources.

14. The device of claim 10, wherein establishing the communications link with an external device triggers transmitting of the data representing the device error codes via the communications link.

15. A method, comprising:
executing, on a processing unit of a device, an error logging algorithm embodied in a non-transitory computer readable medium;
determining, using the error logging algorithm, whether or not a device failure of the device has been detected;
logging, in a memory coupled with the processing unit, data representing a device error code for each device failure detected;
establishing, using the processing unit, a communications link with an external system the data representing the device error code; and
transmitting, via the communications link, the data representing the device error code to the external system.

16. The method of claim 15 and further comprising:
accumulating the data representing one or more of the device error codes in the memory; and
transmitting, via the communications link, the data representing the device error code to the external system after a period of time has elapsed.

17. The method of claim 15 and further comprising:
accumulating the data representing one or more of the device error codes in the memory; and
transmitting, via the communications link, the data representing the device error code to the external system after a number of the data representing the device error code has been accumulated in the memory.

17. The method of claim 15 and further comprising:
performing a hashing function on the data representing the device error code.

18. The method of claim 17, wherein the performing the hashing function occurs prior to the logging.

19. The method of claim 17, wherein the performing the hashing function occurs prior to the transmitting.

20. The method of claim 15, wherein the communications link constitutes a wireless communications link.
